(19) United States
(12) Patent Application Publication
(10) Pub. No.: US 2021/0259394 A1
(43) Pub. Date: Aug. 26, 2021

(54) ADHESIVE EYEBROW COVER

(71) Applicants: Natalie Patterson, St. George, UT (US); Robert Patterson, St. George, UT (US)

(72) Inventors: Natalie Patterson, St. George, UT (US); Robert Patterson, St. George, UT (US)

(21) Appl. No.: 17/180,158

(22) Filed: Feb. 19, 2021

Related U.S. Application Data
(60) Provisional application No. 62/980,784, filed on Feb. 24, 2020.

(51) Int. Cl. A45D 44/12; C09J 7/25

(52) U.S. Cl. CPC A45D 44/12; C09J 7/25; C09J 2301/122; C09J 2483/006; C09J 2301/204

(57) ABSTRACT

An eyebrow cover has a primary layer, an adhesive layer, an adhesive release liner, and a top release liner. The primary layer may be flexible so as to conform to an eyebrow and the structure of a user's face. The primary layer may be shaped so as to surround the eyebrow, minimizing excess coverage on the face while protecting the microblading procedure. Further, the adhesive layer may surround a non-adhesive portion of a lower surface of the primary layer. To protect the eyebrow cover, the adhesive release liner may releasably adhere to the adhesive layer.

### CROSS-REFERENCE TO RELATED APPLICATIONS

This application claims the benefit of U.S. Provisional Application Ser. No. 62/980,784, filed on Feb. 24, 2020, which is incorporated herein by reference.

### TECHNICAL FIELD

The present disclosure relates to an eyebrow cover. More particularly, the present disclosure relates to an adhesive eyebrow cover to protect eyebrows after a microblading procedure.

### BACKGROUND

Microblading emerged from countries in Asia and has made its way to the United States, becoming a popular alternative to eyebrow tattooing. Microblading is a semi-permanent tattoo procedure that creates a fuller brow. Microblading utilizes a small tool, with several small needles, that cuts the skin to introduce tattoo ink. This cutting disrupts the integrity of the epidermis, leading to a necessary healing period. Typically, after being a recipient of a microblading procedure, there are many daily events that should be avoided for 7-10 days, such as washing the face, taking a shower, excessive sweating, swimming, and many other events that may disrupt the healing process. Truly, one of the most difficult parts of the microblading process is keeping the eyebrows dry during the healing process.

Without taking precautions, healing may be delayed, or the procedure will not be as effective as it should. There have been many attempts to protect or cover the eyebrows after a microblading procedure; however, those attempts have many inadequacies. For example, attempts have included a plastic facial shower guard that covers the entire face, water resistant creams, and strips of plastic wrap. Even though these attempts have been made, they have failed to adequately protect the eyebrows while, for example, showering, and are difficult and/or cumbersome to use. Further, they are not helpful for other daily events previously mentioned, such as washing the face or when sweating.

Accordingly, there is a need to have a simple, small adhesive cover that can protect the eyebrows during daily events, such as showering, swimming, and washing the face.

### SUMMARY OF EXAMPLE EMBODIMENTS

In one embodiment, an adhesive eyebrow cover (hereinafter referred to as “eyebrow cover”) comprises a primary layer, an adhesive layer, a release liner, and a top release liner. The primary layer may be a flexible material that can conform to the unique structures of a user's face. Further, the adhesive layer may circumscribe a non-adhesive portion of a lower surface of the primary layer.

In one embodiment, a method of applying an eyebrow cover to a user comprises removing a release liner, positioning a non-adhesive portion of a primary layer over an eyebrow, and pressing an adhesive layer to the epidermis creating a watertight seal.

### BRIEF DESCRIPTION OF THE DRAWINGS

FIG. 1 illustrates a bottom plan view of an adhesive eyebrow cover for a right eyebrow;

FIG. 2 illustrates a top plan view of an adhesive eyebrow cover for a right eyebrow;

FIG. 3 illustrates a bottom perspective view of an adhesive eyebrow cover with a release liner being removed therefrom;

FIG. 4 illustrates a perspective view of an adhesive eyebrow cover coupled to a user;

FIG. 5 illustrates a perspective view of an adhesive eyebrow cover with a top release liner being removed therefrom; and

FIG. 6 illustrates a front perspective view of an adhesive eyebrow cover coupled to a user.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need to have a simple, small adhesive cover that can protect the eyebrows from moisture during daily events, such as showering and washing the face.

Microblading is a technique that disrupts the epidermis, within the eyebrow, due to a microblading device cutting the epidermis and inserting ink. This process leads to a mandatory healing period, which requires that a user keep each eyebrow dry. Keeping the eyebrows dry can become extremely difficult, especially when showers, washing the face, and other events with water are a daily occurrence. Additionally, sweat entering the eyebrow may also delay healing and cause irritation to a user. As a result, the eyebrow cover disclosed herein provides the user a means to carry out the typical daily events involving water or sweat on the face without hindering the healing process.

To use the eyebrow cover, the user can remove a release liner from the eyebrow cover, exposing an adhesive layer, and position it over and around each eyebrow. The eyebrow cover may be used for the right and left eyebrows. Ideally, the eyebrow cover is configured to cover a typical eyebrow. For example, the eyebrow cover is preferably non-rectangular so as to cover an eyebrow without any adhesive overlapping the eyebrow hair. The adhesive layer may circumscribe a non-adhesive portion of the eyebrow cover that receives the eyebrow, ensuring that the eyebrow hair is not in contact with the adhesive. As the user applies the eyebrow cover, the adhesive layer may be positioned around or outline each eyebrow so that the adhesive layer will not contact the healing epidermis or hair. The eyebrow cover can then prevent water from contacting the healing epidermis, allowing the user to shower, swim, etc.

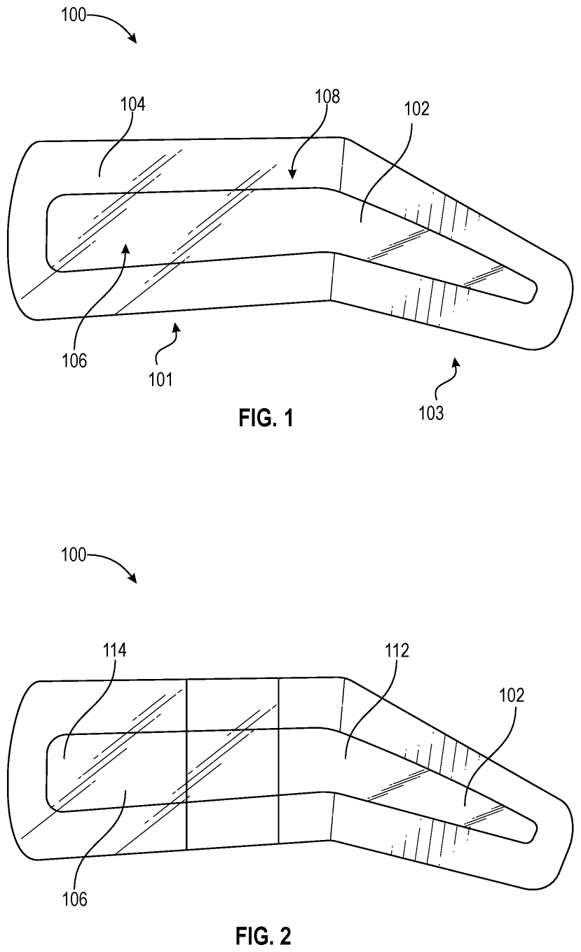

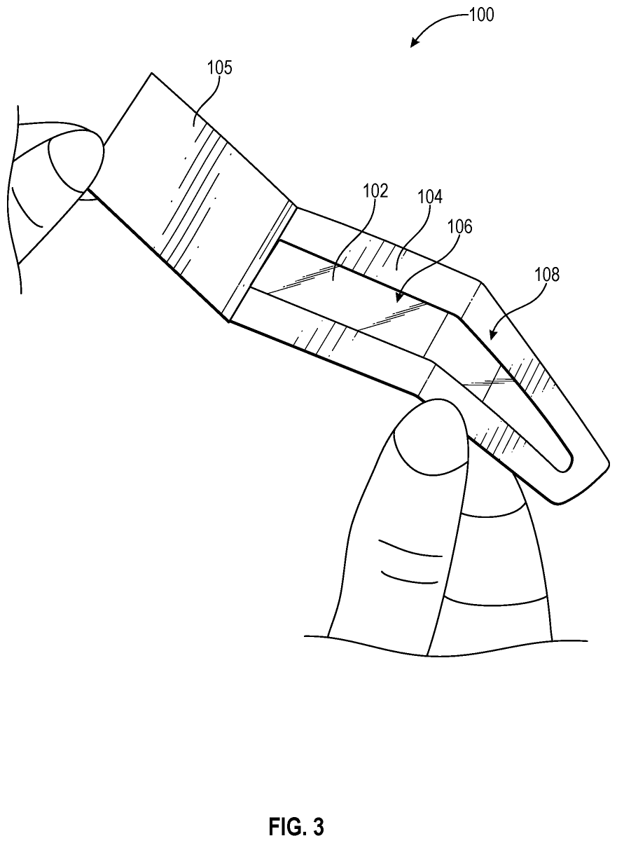

In one embodiment, as shown in FIGS. 1-3, an eyebrow cover 100 comprises a primary layer 102, an adhesive layer 104, and an adhesive release liner 105 (which may be in one or more sections for ease of release). The primary layer 102 may be a flexible material so as to conform to an eyebrow and the structure of a user's face. The primary layer 102 may be, but is not limited to, latex, silicone, woven fabric, plastic (e.g., polyurethane), or any other suitable waterproof material. While the primary layer 102 may be flexible, it will be appreciated that the primary layer 102 may also be non-flexible, such as a hard plastic, aluminum, glass, or any other material that will not flex and is waterproof. The primary layer 102 is shaped so as to surround the eyebrow, minimizing excess coverage on the face while still protecting the eyebrow. For example, a first portion 101 of the eyebrow cover 100 may be substantially horizontal, with a second portion 103 angled downwardly therefrom. This shape allows the eyebrow cover to fully cover the eyebrow without the adhesive layer interfering with the eyebrow hair or the wounds.

It will be appreciated that the shape of the primary layer 102 may vary and reflect the numerous shapes of eyebrows. For example, the eyebrow cover 100 may be shaped to conform to any of the common eyebrow shapes, such as s-shaped, hard angled, soft angled, straight, and rounded. Not only can the shape of the primary layer 102 vary, but the color may also vary. The colors of the primary layer 102 may include, but are not limited to, blonde, auburn, chocolate, dark brown, and ebony. When using various colored primary layers 102, a user may be able to conceal the primary layer 102 against the skin. Additionally, colored primary layers may assist a user in properly placing the eyebrow cover 100 around an eyebrow. In one embodiment, specific colors may be used to indicate day of use. For example, each day of use could have a different color, allowing a user to easily determine when a 7-day period is completed (when removing and replacing each day, although not required). Further, the primary layer 102 may be a clear material, made from materials discussed above, so that a user may be able to visualize the eyebrow and surrounding epidermis while applying the eyebrow cover 100 and after the eyebrow cover 100 has been placed over the eyebrow.

Further, the adhesive layer 104 may circumscribe a non-adhesive portion 106 of a lower surface 108 of the primary layer 102. The non-adhesive portion 106 may protect the eyebrow from coming in contact with water and from an adhesive material potentially adhering to the healing epidermis. The adhesive layer 104 may circumscribe the non-adhesive portion 106 with continuous adhesive. Alternatively, the adhesive layer 104 may circumscribe the non-adhesive portion 106 in an alternating pattern of adhesive and non-adhesive, such as stripes or dots. The adhesive layer 104 may be a diacrylate, a methacrylate, or other suitable composition or adhesive.

The release liner 105 may be made of a coated paper, plastic, or other protective material that may releasably adhere to the eyebrow cover 100. In particular, the release liner 105 may be releasably adhered to the adhesive layer 104 to protect the adhesive layer 104 until ready for use by a user. Further, the release liner 105 may be a single piece or may be in multiple pieces or sections. In one embodiment, the release liner 105 may comprise tabs to assist a user in removing the release liner 105. For example, the user would grasp a tab and pull it away from the adhesive layer 104, exposing the adhesive layer 104 in preparation for adhering the eyebrow cover 100 around an eyebrow.

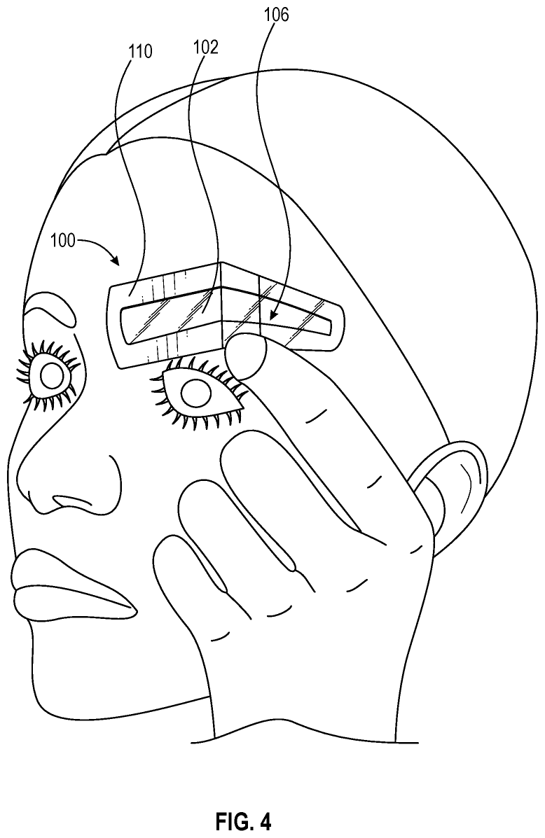

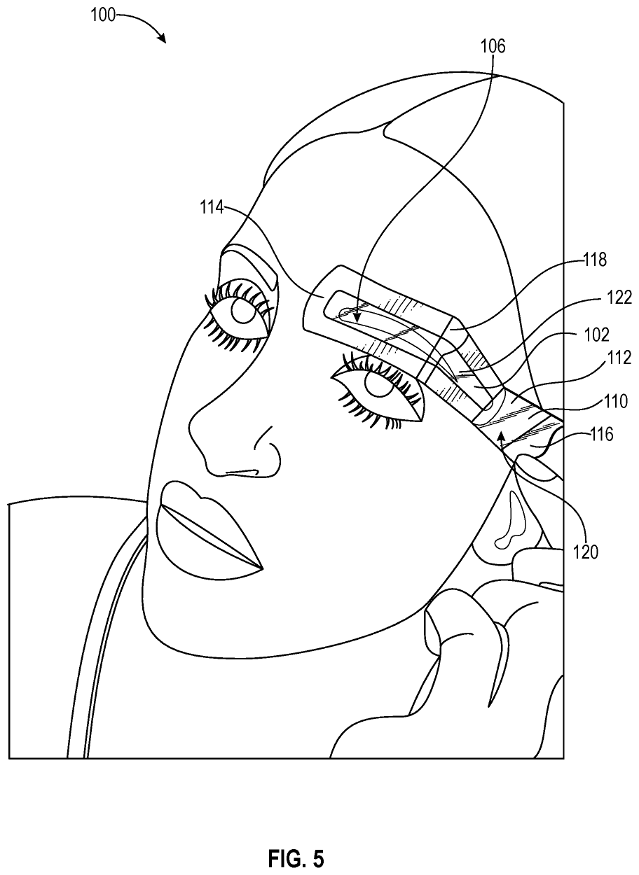

Further, in some embodiments, the eyebrow cover 100 may comprise a top release liner 110 (shown in FIGS. 4-5) for providing stability to the eyebrow cover 100 during application and to prevent the primary layer (e.g., a thin film) from folding and adhering to itself prior to application. The top release liner 110 may be made of a coated paper, plastic, or other protective material that may releasably adhere to the eyebrow cover 100 and add structural support thereto until removed. The top release liner 110 may be multiple pieces. For example, as shown in FIG. 5, the top release liner 110 may comprise a first section 112 and a second section 114 that overlap. The first section 112 may comprise a first tab 116, and the second section 114 may comprise a second tab 118. The tabs 116, 118 are not adhered to the primary 102, allowing a user to easily lift the tab and pull to release the portions of the top release layer 110 that are adhered. The first and second tabs 116, 118 may also be color coded to assist the user in removing the first and second sections 112, 114, respectively. Alternatively, the top release liner 110 may be a single section. As mentioned, a lower surface of the first and second sections 112, 114 may comprise a top adhesive layer 120 so as to be releasably adhered to an upper surface 122 of the primary layer 102. Once the eyebrow cover 100 is adhered to a user over the eyebrow, the user may then remove the top release liner 110 by grasping and pulling the first tab 116 to remove the first section 112 and the second tab 118 to remove the second section 114, allowing the eyebrow cover 100 to have an ultra-low profile on a user.

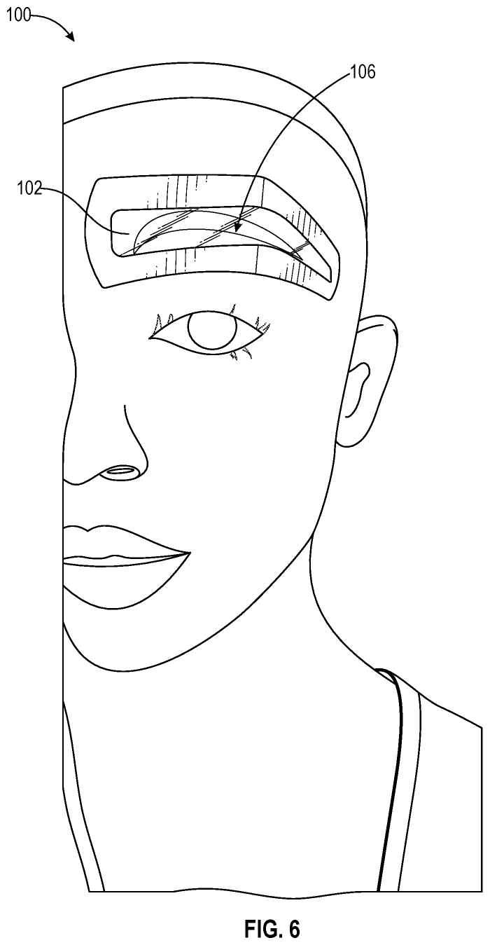

In one embodiment, as shown in FIGS. 3-6, a method of applying an eyebrow cover 100 to a user comprises removing a release liner 105 from the adhesive layer 104, positioning a non-adhesive portion 106 of a primary layer 102 over an eyebrow, pressing the adhesive layer 104 to the epidermis surrounding the eyebrow creating a watertight seal, with the non-adhesive portion covering the eyebrow. If equipped with a top release liner 110, removing the top release liner 110. More specifically, a user may grasp and pull the first tab 116 to remove the first section 112 and the second tab 118 to remove the second section 114. When a user is finished using the eyebrow cover, such as after a water activity (e.g., face washing, shower, etc.), the user may remove the eyebrow cover 100 by peeling it off.

Additionally, in one embodiment, the primary layer 102 may comprise a structure with a void between a top and bottom of the structure. In other words, the void may be surrounded by the structure. A thin film (transparent or opaque) may be coupled to the structure, extending across the void. The film may be adhered to the structure or manufactured with the structure. Further, an adhesive layer may be positioned on a lower surface of the structure.

It will be appreciated that the eyebrow cover 100 allows a user to easily protect each eyebrow after a microblading procedure. The eyebrow cover is simple to use, effective, and protects the eyebrows during any daily activity involving water. Further, it could be envisioned that the eyebrow cover may have other end uses, such as protecting stitches or wounds in the eyebrow.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An eyebrow cover comprising:
a primary layer;
an adhesive layer circumscribing a lower surface of the primary layer, the adhesive layer configured to circumscribe a user's eyebrow;
an adhesive release liner releasably adhered to the adhesive layer;
wherein when the adhesive release liner is removed, a user may position the eyebrow cover over the eyebrow and adhere the adhesive layer to the epidermis.

2. The eyebrow cover of claim 1, wherein the primary layer comprises a flexible material to conform to the user's face.

3. The eyebrow cover of claim 2, wherein the flexible material comprises silicone.

4. The eyebrow cover of claim 1, wherein the primary layer comprises a non-adhesive portion on the lower surface.

5. The eyebrow cover of claim 4, wherein the adhesive layer comprises a continuous adhesive circumscribing the non-adhesive portion.

6. The eyebrow cover of claim 4, wherein the adhesive layer circumscribes the non-adhesive portion with an alternating pattern of adhesive and non-adhesive.

7. The eyebrow cover of claim 1, further comprising a top release liner releasably adhered to an upper surface of the primary layer for providing stability to the eyebrow cover during application.

8. The eyebrow cover of claim 1, wherein the adhesive release liner comprises a single piece of material.

9. An eyebrow cover comprising:
a primary layer comprising a flexible material to conform to a user's face;
an adhesive layer circumscribing a non-adhesive portion on a lower surface of the primary layer;
an adhesive release liner releasably adhered to the adhesive layer;
a top release liner releasably adhered to an upper surface of the primary layer;
wherein when the adhesive release liner is removed, the user may position the eyebrow cover over an eyebrow, securing the adhesive layer to the epidermis around the eyebrow.

10. The eyebrow cover of claim 9, wherein the adhesive layer comprises a continuous adhesive circumscribing the non-adhesive portion.

11. The eyebrow cover of claim 9, wherein the adhesive layer circumscribes the non-adhesive portion with an alternating pattern of adhesive and non-adhesive.

12. The eyebrow cover of claim 9, wherein the adhesive release liner comprises a single piece of material.

13. The eyebrow cover of claim 9, wherein the top release liner comprises a first section separable from a second section.

14. A method of applying an eyebrow cover to an eyebrow of a user, comprising:
grasping the eyebrow cover, the eyebrow cover comprising:
a primary layer,
an adhesive layer circumscribing a non-adhesive portion on a lower surface of the primary layer,
an adhesive release liner releasably adhered to the adhesive layer, and
a top release liner releasably adhered to an upper surface of the primary layer;
removing the adhesive release liner from the adhesive layer;
positioning the non-adhesive portion of the primary layer over the eyebrow;
pressing the adhesive layer of the primary layer to an epidermis surrounding the eyebrow; and
removing the top release liner from the upper surface of the primary layer, forming a waterproof seal around the eyebrow.
